(19) United States
(12) Patent Application Publication
(10) Pub. No.: US 2014/0255586 A1
(43) Pub. Date: Sep. 11, 2014

(54) HOP RESIN-BASED SUBSTANCE

(71) Applicants: Josef Schulmeyr, Wolnzach (DE); Michael Dresel, Gent (BE); Thomas Hofmann, Neufahrn (DE)

(72) Inventors: Josef Schulmeyr, Wolnzach (DE); Michael Dresel, Gent (BE); Thomas Hofmann, Neufahrn (DE)

(73) Assignee: JOH. BARTH & SOHN GMBH & CO. KG, Nurnberg (DE)

(21) Appl. No.: 13/982,157

(22) PCT Filed: Jan. 27, 2012
(86) PCT No.: PCT/EP12/00370

§ 371 Date: Oct. 23, 2013

(30) Foreign Application Priority Data
Jan. 28, 2011 (DE) 10-2011-009-781.3

(51) Int. Cl. C12C 3/10

(52) U.S. Cl. CPC C12C 3/10
USPC 426/600; 426/429

(57) ABSTRACT

A hop resin-based substance has the soft resin at least substantially removed such that the hard resin is present in an enriched state, the hard resin is enriched in terms of the water-insoluble constituents and xanthohumol has been, at least substantially, removed. The substance allows both very balanced bitterness to be adjusted and it does not constitute any optical impairment of beer due to insoluble matter caused by xanthohumol.

### TECHNICAL BACKGROUND

Hops are used mainly in the brewing industry as a means to adjust the bitter content of beer. Today, natural hops are processed for the recovery of the bitter substances of hops in the form of hop pellets or hop extracts. The hop pellets or hop extract is added to the wort in the brewing process, in order to thereby adjust the bitter content of the beer. Hops include both soft resins and hard resins. In practice until today, the soft resins of hops, such as humulones (also called alpha acids) are used for the brewing process. These are obtained by extraction of the umbels of hops. On the other hand, hard resins are widely regarded as worthless, see for example DE PS 941 966 or DE 37 43 058 A1. An extraction residue containing hard resin (also called “grains”) is regarded as a waste product from today's perspective and is currently used either as fodder or fuel.

### STATE OF THE ART

A method is known from DE OS 2 223 698 for the purification of hop extracts by the removal of the unwanted xanthohumol whereby a solution of the hop extract is brought into contact with a polyamide in a suitable solvent. The hop extract thus freed of xanthohumol may include both soft and hard resins.

DE 33 46 776 C2 relates to a process for the extraction of hop content with supercritical carbon dioxide at pressures up to 300 bar and temperatures from 110° C. to 150° C., whereby there results an increase in yield of the total resins as a result of the increased extraction of the hard resins.

A method is known from EP 1 424 385 B1 of xanthohumol-enriched hop extract whereby the hops are obtained in a one or two CO₂ stage extraction process at high pressures.

### OBJECT OF THE INVENTION

The object of the present invention is to produce a novel substance based on hops as well as a method of production thereof, which leads to an improved yield of useful substances contained in the hops for the brewing process, as well as for other possible applications.

### SOLUTION ACCORDING TO THE INVENTION

The above object is achieved through a substance on the basis of hop resin, whereby the soft resin is removed, at least substantially, while the hard resin, at least substantially, is present as the main resin component and is enriched with respect to the water-insoluble constituents, while the xanthohumol, at least substantially, is removed.

Advantageous embodiments of the substance of the invention are claimed in the dependent claims.

It has been shown that the substance of the invention enables adjustment of a very balanced bitterness of the beer during the brewing process without impairment of the optical quality (clarity, homogeneity) that often occurs in the presence of xanthohumol. The substance according to the present invention can be recovered from the spent hops obtained as a waste material after the extraction of the soft resins. Thus the spent hops can also serve as the starting product for a substance produced therefrom that is introduced into the brewing process. The usability of a unit of weight of hops in the brewing process can thus be considerably enhanced by the invention. According to the invention, the hard resin is at least substantially free of xanthohumol. It is thus almost xanthohumol-free as well as being a virtually water-insoluble fraction of hard resin. This allows adjustment to a particularly pleasant, mild bitterness of the beer with good optical quality. Thus the xanthohumol-free fraction of the hard resin offers two advantages, on the one hand a very balanced bitterness on the other no visual impact on the beer produced in the brewing process.

Advantageously, the proportion of xanthohumol is less than 50 mg/g, preferably, less than 25 mg/g of hard resin.

The proportion of water-soluble constituents of the hard resin in the substance of the invention is preferably less than 100 mg/g, preferably less than 50 mg/g of the hard resin.

The inventive method for producing the substance described above is characterized by the following steps:

Provision of a hop product whereby the hard resin is present, at least substantially, as the main resin component, removal of the water-soluble constituents of the hard resin, so that the hard resin with respect to the water-insoluble constituents thereof is enriched, and removal of the xanthohumol, so that the substance is at least substantially free of xanthohumol.

According to the invention, the starting point of the method can be a hop starting material comprising both soft resin as well as hard resin, whereby the soft resin components are then removed from the hop starting material, so that a hop product is created and made available, and in which the hard resin is present, at least substantially, as the main component.

Alternatively, the so-called CO₂ hop extract-grains can also be provided, from which the soft resin components have already been removed.

The removal of the water-soluble components of the hard resin is advantageously carried out by extracting the hops, e.g., in the form of hop pellets through, preferably supercritical, CO₂ at a pressure of more than 500 bar up to a pressure of 1,000 bar, preferably at a pressure of 500-1,000 bar, preferably at a pressure of 700-1,000 bar. This yields a nearly water-insoluble hard resin fraction.

The aforementioned CO₂ extraction is advantageously carried out in a temperature range from 50° C. to 120° C., preferably 70° C. to 120° C.

During the CO₂ extraction of the water-insoluble resin components, a solvent for polar compounds may advantageously be added, for instance in an amount of 1-20 wt-%. This makes it possible to dissolve polar components in the hops to enrich the extract. Ethanol or methanol is particularly suitable for this.

Proportions of xanthohumol may be removed from the extract whereby the extract obtained is dissolved or suspended in an alkaline solution, preferably sodium hydroxide solution. This is followed by neutralization and precipitation of the dissolved xanthohumol using an acid, preferably hydrochloric acid, as described in the German patent DE 10 2006 018 988 B3.

Alternatively, the xanthohumol could also be removed in the manner described in the aforementioned DE OS 2 223 698.

An alternative embodiment of the method is characterized in that a CO₂ hop extract grain obtained as a waste product in the hop processing process is used as a starting material of the method, and whereby this is then extracted in a leaching step using, preferably supercritical, CO₂ at a pressure of 500 bar to 1,000 bar, preferably 700 to 1,000 bar.

A solvent for polar compounds, e.g., ethanol, can be advantageously added during the CO₂ extraction or CO₂ leaching of the hops at these high pressures, for example in an amount of 1-20 wt-%. This makes it possible to dissolve polar components from the hops and enrich the extract.

Proportions of xanthohumol can be removed here also from the extract in the manner previously described,

### EXEMPLARY EMBODIMENT 1

10 kg of hop pellets are extracted under supercritical CO₂ conditions at 300 bar and 60° C. using CO₂. First of all, the soft resins are dissolved. The extraction residue is then leached in a second step (in the same system or on a separate system) with CO₂ at 700 bar and 85° C. Ethanol is added in an amount of 4 wt-% during this extraction. Polar compounds and water-soluble constituents are dissolved here, the latter at least substantially. The extract obtained from the leaching contains xanthohumol. Starting from the extract, the xanthohumol is separated in ethanol and subjected to subsequent treatment with sodium hydroxide as well as subsequent neutralization and precipitation with hydrochloric acid. The hard resin fraction is recovered from the neutralized solution to produce a water-insoluble, substantially xanthohumol-free hard resin fraction.

### EXEMPLARY EMBODIMENT 2

10 kg of CO₂ spent grains are extracted at 700 bar and 85° C. Ethanol in an amount of 4 wt -% is added during this extraction. Polar compounds and water-soluble constituents are dissolved here, the latter at least substantially. The extract obtained by the extraction contains xanthohumol. The removal of xanthohumol is in accordance with the approach described in exemplary embodiment 1.

### EXEMPLARY EMBODIMENT 3

The hard resin fraction obtained according to exemplary embodiment 1 or 2 is added to the wort in a brewing process for adjusting the bitter content of a brewery product.

### EXEMPLARY EMBODIMENT 4

The hard resin fraction obtained according to exemplary embodiment 1 or 2 is obtained with a suitable solvent (such as ethyl acetate or ethanol) and sprayed as a solution on foodstuffs or the like to prevent the formation of micro-organisms and yeasts.

1. Substance on the basis of hop resin, whereby
a soft resin, at least substantially, is removed while a hard resin is enriched, the hard resin is enriched thereof with respect to water-insoluble constituents of the hard resin while xanthohumol, at least substantially, is removed;
wherein the proportion of water-soluble constituents of the hard resin is less than 100 mg/g of the hard resin.

2. A substance according to claim 1, wherein the proportion of xanthohumol is less than 50 mg/g, preferably less than 25 mg/g of the hard resin.

3. A substance according to claim 1, wherein the proportion of water-soluble constituents of the hard resin is less than 50 mg/g of the hard resin.

4. A method to produce a substance on the basis of hop resin, in particular a substance according to claim 1, comprising:
providing a hop product whereby the hard resin, at least substantially, is present as a main resin component;
removing water-soluble constituents of the hard resin, so that the hard resin is enriched with respect to the water-insoluble constituents;
removing xanthohumol, so that the substance is at least substantially free of xanthohumol;
providing a hop product whereby the hard resin is at least substantially present as the main resin component by providing a CO₂ hop extract grain;
removing the water-soluble constituents of the hard resin by extracting the hop product with CO₂; and
adding a solvent for polar compounds during the CO₂ extraction of the hop product so that the proportion of water-soluble constituents of the hard resin is less than 100 mg/g of the hard resin.

5. A method according to claim 4, comprising using a hop output product comprising both soft resin and hard resin; and removal of the soft resin components from the hop starting product, so that a hop product is created and provided, whereby the said hard resin is present, at least substantially, as the main resin component.

6. A method according to claim 4, wherein the removing the water-soluble constituents of the hard resin is effected by extraction of the hop product with supercritical CO₂, in a pressure range of 500 bar-1,000 bar, preferably 700 bar-1,000 bar.

7. A method according to claim 6, wherein the CO₂ extraction is effected in a temperature range of 50° C. to 120° C.

8. A method according to claim 4, wherein the solvent for polar compounds is an alcohol.

9. A method according to claim 4, wherein the removing the water-soluble constituents of the hard resin, instead of using CO₂ extraction, is effected by using extraction of the hop product using an organic solvent.

10. Using the substance according to claim 1 as means for adjusting bitterness of beer in the beer brewing process.

11. A method according to claim 6, wherein the CO₂ extraction is effected in a temperature range of 70° C. to 120° C.

12. A method according to claim 4, wherein the solvent for polar compounds is ethanol or methanol.

13. A method according to claim 9, wherein the organic solvent comprises ethanol or methanol.
